(19) United States
(12) Patent Application Publication
(10) Pub. No.: US 2008/0098446 A1
(43) Pub. Date: Apr. 24, 2008

(54) Multicast and Broadcast Streaming Method and System

(75) Inventors: Gamze Seckin, Izmir (TR); Lali Sarna, Haryana (IN); Jayank M. Bhalod, Kenmore, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Vidiator Enterprises Inc,, Nassau (BS)

(21) Appl. No.: 11/659,886

(22) PCT Filed: Aug. 11, 2005
(86) PCT No.: PCT/US05/28682

§ 371 Date: Sep. 25, 2007

Related U.S. Application Data
(60) Provisional application No. 60/600,847, filed on Aug. 11, 2004.

(51) Int. Cl. H04N 7/173

(52) U.S. Cl. 725/114

(57) ABSTRACT

In a multicast and/or broadcast streaming environment over wired and/or wireless networks, a server provides a plurality of different streams to each group (such as multicast groups) of client devices. Each of the client devices in the respective groups tune in to one of the plurality of streams that is most optimum. Quality of Experience (QoE) metric data or other data pertaining to dynamically changing client device characteristics or channel conditions are collected and evaluated by the server. If results of the evaluated metric data recommend a change to a different stream for a particular one or more client devices, the server switches the client device(s) to a different stream in the same group, or switches the client device(s) to a different stream in a different group if that stream is not available in the current group.

### BACKGROUND OF THE INVENTION

1. Field of the Invention

This disclosure generally relates to the delivery of data across a communication network to client devices, and more particularly but not exclusively relates to a system and method for streaming data to client devices across wired and/or wireless networks in a multicasting and/or broadcasting environment.

2. Description of the Related Art

There are various techniques that can be used to deliver data to client devices across communication networks—multicasting and broadcasting are two examples. In at least some types of multicasting environments, a plurality of multicast groups is provided, wherein subscribing members (e.g., client devices) receive multicast session data, service(s), content, or other data that is made available to subscribing members through the multicast group. The multicast groups may each provide the same basic content, such as a particular video program, but there may be differences between the signals available in each of the multicast groups. For example, each multicast group might transmit the video program at a different bit rate than other multicast groups.

In such a multicasting environment, client devices or other recipients desiring to receive the video program can subscribe to or otherwise join a particular multicast group in order to receive the transmission. Typically, each client device selects the appropriate multicast group to join based on the bit rate provided or based on some other compatible characteristic. Accordingly as an example, Multicast Group 1 might provide a video program at Bit Rate A to Client Devices 1-10, Multicast Group 2 might provide the same video program at Bit Rate B to Client Devices 11-14, Multicast Group 3 might provide the same video program at Bit Rate C to Client Devices 15-21, and so forth.

As is often the case, certain conditions may make the initial bit rate non-ideal for a particular client device. For instance, network bandwidth conditions or client device characteristics that change dynamically during a session may dictate that the particular client device switch to a lower (or higher) bit rate. However, frequently changing from one multicast group to other multicast groups can result in adverse consequences. One consequence is expense. It costly for a client device to switch from one multicast group to another (e.g., connect and disconnect, and vice versa), since fees or other procedural requirements may need to be satisfied in order to subscribe to a new multicast group. Another consequence is disruption of service. That is, switching from one multicast group to another multicast group during transmission of a video program may result in loss of some portion of the video program during the transition—changing between multicast groups is often not a seamless experience.

With developments in media compression and wireless network infrastructures, media streaming has become a promising area of technology for end users, content providers, wireless operators, and other entities. Although there will be more bandwidth available for wireless technologies such as 2.5 G or 3 G and despite the fact that some of the advanced compression techniques enable very low-bit-rate streaming, there are inherent problems when it comes to the wireless environment. Such problems are further compounded by the multicast environment described above wherein it may not be optimal for a client device to switch to another multicast group in order to get a more optimum signal—the client device may have no better choice other than to remain in the same multicast group and “make the best” of the situation.

Areas of wireless streaming applications where such problems are encountered include real-time media applications (including both audio and video streaming), real-time audio applications (such as live music or sports broadcasts), off-line media applications, and off-line audio applications. Unlike wired networks, wireless networks suffer from high rates of effective packet loss and intermittent packet delays, as well as other problems. Packet loss and delays may be caused by factors such as network congestion, bit error rates, or data overflow at the user's device apart from effects, such as fading, which is an inherent characteristic of wireless networks.

In addition to packet loss, there are other factors that adversely affect the media received by the end user. The effect of any of these factors on the user experience can vary greatly depending on communication channel conditions, user device characteristics, environmental conditions, voluntary or involuntary events that occur during communication, or other influences.

All of the above-described and other factors ultimately adversely affect the Quality of Experience (QoE) and for the end user in a mobile wireless multicasting environment in the context of media delivery and consumption, wherein streaming is but one example of media delivery. These same or other factors can also adversely affect a multicasting session for the end user in a hardwired communication network. These same or other factors can also adversely affect a broadcasting session in a hardwired or wireless communication network, particularly since all users generally receive the same signal in a broadcasting environment and therefore the capability to switch to a different signal is limited, if not impossible.

### BRIEF SUMMARY OF THE INVENTION

According to one aspect, a method to deliver streaming content to a plurality of client devices is provided. The method includes associating client devices with groups. Multiple simultaneous unique streams are delivered to each group to allow client devices in each group to respectively receive one of the unique streams. Metric data pertaining to the delivery of the streams to the client devices is received and evaluated. Based at least in part on the evaluated metric data, at least one of the client devices is caused to switch to a different stream in a same group that is more optimum than a current stream in the same group. Based at least in part on the evaluated metric data, the at least one of the client devices is caused to switch to a different stream in a different group that is more optimum than a current stream in a current group, if the optimum stream is unavailable in the current group.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an example system that can implement one embodiment of the invention.

FIG. 2 is a block diagram illustrating delivery of content to groups of client devices using multiple streams according to one embodiment.

FIG. 3 is a flowchart of an embodiment of a technique to deliver content to groups of client devices, including switching between streams and groups, according to one embodiment.

### DETAILED DESCRIPTION OF THE INVENTION

Embodiments of techniques to provide streaming data to client devices in multicast and/or broadcast environments are described herein. In the following description, certain specific details are set forth in order to provide a thorough understanding of various embodiments. However, one skilled in the art will understand that the present systems and methods may be practiced without these details. In other instances, well-known structures and protocols associated with communications equipment and protocols have not been shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

As an overview, an embodiment provides a technique for delivering streaming data in a multicast and/or broadcasting environment from at least one server to a plurality of client devices. The streaming data may be delivered over either or both wireless and hard wired communication networks. The streaming data can include, but is not limited to, video, audio, files, live or recorded programs, multimedia content, services, or other type of data or combinations thereof. The client devices can include portable wireless devices (such as cellular telephones), laptops, and the like. The client devices can also include wired devices such as personal computers, workstations, and the like.

In an embodiment, client devices can subscribe or otherwise join multicast groups to receive the data being delivered by the server(s). The server can stream multiple signals, having for example multiple different bit rates, for each multicast group. Thus, different multiple bit rates can be provided to each multicast group. The client devices in the respective multicast groups can tune in to a particular signal that corresponds to their optimum bit rates, resolution, format, etc. for example.

In one embodiment, the server can instruct a client device to change/switch to a different signal (having a different bit rate, for example) provided in the same multicast group, if client device characteristics and/or channel conditions indicate that such switching will provide more optimum service. In one example embodiment, the server has multiple streams available for a group, but the server streams the most proper (e.g., most optimum for the group as a whole) stream at one particular time (one stream at a time) and does adaptation “seamlessly” for that group. In such an embodiment, only when it comes to changing groups, the server (or the client device) exchange signals. In another embodiment, multiple streams are provided to a group by the server and each of the streams are tailored to the particular client devices in the group, and further, the client devices (singly, a plurality, or all) can change to a different stream in the same group or to a different stream in another group.

In an embodiment, the server can also instruct a client device to switch to a different signal that is available in some other multicast group (i.e., instruct the client device to switch to another multicast group) in order to obtain a more optimum service. Such a switch from one multicast group to another can be performed, for instance, if the present multicast group does not provide a desirable bit rate for the client device and/or the end user experience as a whole would be more optimum with some other multicast group.

Various techniques can be used to gather and use information before, during, and after streaming sessions to determine whether or not a client device should switch to another signal in the same multicast group, and/or to switch to another signal in a different multicast group. For instance, one embodiment uses dynamic bandwidth adaptation (DBA) and/or Quality of Experience (QoE) techniques to assist in making such determinations.

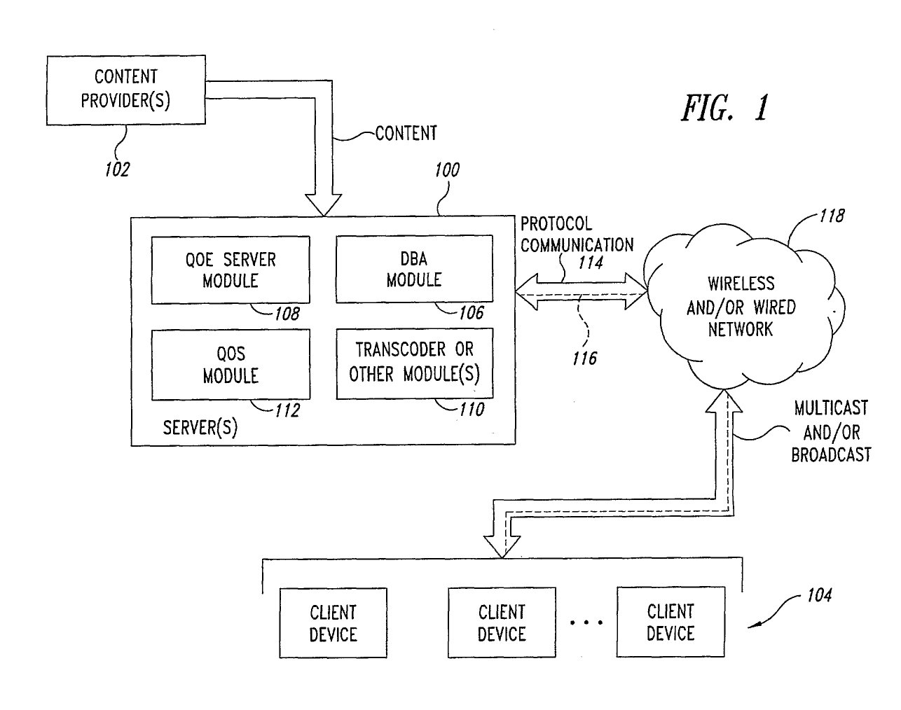

FIG. 1 is a block diagram of a system that can implement an embodiment of the invention. At least one server 100 receives content from one or more content providers 102. The content provided by the content provider 102 can include, but not be limited to, audio, video, movies, music, live or recorded programs, files, games, Internet content, multimedia, instant messages, on-demand content, or any other type of data that can be communicated by the server 100 to a plurality of client devices 104. In one embodiment, the server 100 can communicate/deliver such content using streaming techniques. Alternatively or additionally, the server 100 can use downloading or other delivery techniques to deliver this content or other data.

One embodiment of the server 100 incorporates a Dynamic Bandwidth Adaptation (DBA) module 106 and a QoE Server Module 108. Various other embodiments of the server 100 can also include a Quality of Service (QoS) module 112, a transcoder module 110, and/or other modules and components. The various modules may comprise separate modules in some embodiments, while in other embodiments, the various different functionalities may be present or otherwise combined into a single module. Each of these modules and their associated functionality will be described next.

With regards to DBA, one embodiment of the invention allows the streaming of audio or video (A/V) data, for example, to be carefully matched to the bandwidth of a channel to the client device(s) 104. This dynamic bandwidth adaptation comprises two components: (1) the channel's fluctuating bandwidth is monitored, and (2) the DBA module 106 of the server 100 is able to change the streaming bit rate in real time to match or otherwise compensate for variations in the channel's bandwidth. Using this bandwidth monitoring and bit rate adaptation technique, the user is able to receive relatively smoother video and lucid audio.

In accordance with an embodiment of the invention, a DBA algorithm is provided that enables steady streaming quality and smooth transitions during congestion and network resource fluctuation periods. This feature adapts to the characteristics or conditions of a wireless network (such as a shared packet network) by adjusting the rich media stream to suit the client bandwidth, thereby optimizing the end user experience. The DBA algorithm automatically adjusts the audio and video bit rate being served by the server 100 based on the end user's available bandwidth in the network. As such, the end user can receive the most appropriate bit rate stream.

The DBA algorithm provides congestion avoidance and rate control throughout the stream lifetime, by monitoring the channel to each client for statistically significant and persistent changes in the bandwidth that may be associated with packet loss, delay, or delay variation. When these changes occur and when there is an existing closely matching but lower bit rate stream, the DBA module 106 switches over to that lower stream for the particular client device 104. Switching to a higher bit rate stream may also be performed, if bandwidth conditions improve to allow switching to an optimum higher bit rate transmission.

Examples of parameters that can be used to determine whether to increase or decrease bit rate can include, but not be limited to, maximum delay, a delay variance, a maximum loss of packets, instantaneous and previous losses of packets, and other parameters. Loss of packets or other parameters, for instance, can also be based on any one or more of average, cumulative, or consecutive loss of packets, so as to obtain the most intelligent and accurate determination of bandwidth conditions. In one embodiment, the parameters of base delay or delay variation (computed by determining the base delay, and subtracting the base delay from an instantaneous delay to obtain a value for the delay variation) increase tracking information and can be used to further determine, improve, and optimize bandwidth adaptation in accordance with client device or network/operator requirements.

In a streaming session, an embodiment of the DBA module 106 selects an appropriate track at the beginning of the session. Then, if the bandwidth drops or increases during the stream, the DBA algorithm will recommend a bit rate adjustment. In making this recommendation, an embodiment of the DBA algorithm factors in statistical and persistent behavior of the channel and does not react to instantaneous spikes. As a result, media quality is not changed abruptly, and bit rate changes happen smoothly and gradually.

It is noted that an embodiment of the DBA module 106 can work for a group of client devices. Therefore, the DBA module 106 can analyze the data coming from all or a subset of client devices and make a decision for the whole group (and/or for a subset of client devices in the group). This decision may be optimal for some clients in the group but not so optimal for others. For example, if 8 out of 10 client devices (most client devices in a group) can receive a maximum of 64 kbps, the remaining two client devices that wish to receive 128 kbps may not get that bit rate since that may not be the optimal decision. In that case for these “two client devices,” it is better to switch to another group or stay with 64 kbps. Note that each group may further have a switching range. For the group in the example it could be 32 to 128 kbps.

Example embodiments of the DBA module 106 are described in further detail in U.S. application Ser. No. 10/452,035, entitled “METHOD AND APPARATUS FOR DYNAMIC BANDWIDTH ADAPTATION,” filed May 30, 2003, assigned to the same assignee as the present application, and incorporated herein by reference in its entirety.

With regards to QoE, the QoE framework on which one embodiment of the QoE server module 108 is based provides a technique to monitor and address QoE issues that may arise during communications between network components. For example, there may be QoE issues that may arise during communications between the server and one of the client devices 104 when media is being communicated from the server 100 to the client device 104. The components of the QoE framework of one embodiment includes initiation and termination processes that respectively define the beginning and end of a session; a negotiation process wherein the server 100 and the client devices 104 negotiate which QoE metric(s) to use during the session; one or more QoE metrics that are defined and implemented (e.g., collection/measurement of metric values); transportation during the session of metric values pertaining to metrics at a predefined frequency and for a predefined range of the session all of which have been accepted during the negotiation; and analysis/application of the metric values to evaluate the QoE and adjust conditions so that the QoE can be improved, if necessary.

Therefore, the QoE framework of an embodiment assesses end user experience in a communication environment, such as a wireless communication environment. QoE uses a combination of deterministic and subjective methods for analyzing and providing satisfactory data delivery, reliability, availability, scalability, speed, accuracy, efficiency, etc. An embodiment of the QoE framework on which the QoE server module 108 is based is a cross protocol layer concept involving network, transport, operating system, player, codes, client characteristic, and/or any application layer specific issues and other issues that may span different communication protocols. Also in one embodiment, QoE parameters (e.g., QoE metric data) can be separated for media and session level details. That is, a QoE framework of an embodiment examines metric data from a combination of variety of sources that may affect the end user experience, and provides this metric data to the server 100 so that the QoE server module 108 can determine whether and in what manner QoE may for any one or more of the client devices 104 can be improved.

As mentioned above, an embodiment of the QoE framework may involve a negotiation process, which can be performed between the QoE server module 108 and any one or more of the client devices 104. An embodiment of the negotiation protocol can be summarized as follows: a session is initiated between the server 100 and one of the client devices 104; some QoE metrics may or may not be supported by either or both the server 100 and the client device 104; also, the client device 104 may choose to include a subset of the QoE metrics it supports for a particular session; the client device 104 and the server 100 therefore may engage in a negotiation process, which can involve several back and forth exchanges, to determine which QoE metrics are supported and should be sent by the client device 104, how often the supported/accepted QoE metrics should be sent, how to activate and/or deactivate the QoE metrics, the content or value(s) that the accepted QoE metrics are to contain, and other QoE metric-related factors; measurement and collection of QoE metric values by the client device 104; transporting the QoE metric values from the client device 104 to the server 100; and termination of the session. The transported metric values can be evaluated to determine if the QoE can or should be improved during the streaming session and/or for subsequent sessions.

In an embodiment, the client devices 104 measure the QoE metrics at the transport layer, but may also do so at the application layer for better accuracy. The reporting period for the QoE metrics can be the period over which a set of metrics is calculated. The maximum value of the reporting period can be negotiated via the QoE negotiation protocol. In other embodiments, one or more QoE metrics may be measured by elements additionally or alternatively to the client devices 104, and then conveyed to the server 100 and/or to the client devices 104.

In an embodiment, at least some of the metrics are indicative of a characteristic that affects quality in the communication environment, or are some other indication or outcome of the communication channel. Such QoE metrics can be measured at the protocol stack of the client devices 104, application(s) of the client devices 104, buffers of the client devices 104, codecs of the client devices 104, or other client characteristic that can be related to QoE or any combination of the above. The metrics can be used to adjust the behavior at any of these layers at the server 100 and/or at the client devices 104.

The following example QoE metrics can be derived by the client devices 104 implementing QoE: corruption duration, rebuffering duration, initial buffering duration, successive loss of packets, frame rate deviation, jitter duration, and/or any other parameter (singly or in combination) that can affect the QoE. It is appreciated that these QoE metrics are not the only metrics that may be used for QoE purposes. These QoE metrics may be supplemented with other metrics, replaced by other metrics, modified, combined, etc. The QoE metrics are applicable to, for instance, audio, video, speech and timed text media types, and other media types.

The QoE server module 108 of one embodiment is responsible for quantifying the impact of several factors, including network conditions, client characteristics, etc. on the media being communicated. The QoE server module 108 does so by gathering feedback from the client devices 104. The characteristics and features of various embodiments of the QoE server module 108 can be described as follows:
1. The QoE server module 108 can reside on a streaming server (e.g., the server 100).
2. The QoE server module 108 can reside on an RTSP proxy or on any other suitable network device.
3. The QoE server module 108 can accept input from various protocols
4. The QoE server module 108 configuration can be stored in an SDP file or generated by the server/proxy.
5. The QoE server module 108 can interact with the DBA module 106:
   To impact decisions to increase bit rate based on statistical QoE result
   To impact decisions to increase bit rate based on subjective QoE result
   To impact decisions to decrease bit rate based on statistical QoE results
   To impact decisions to decrease bit rate based on subjective QoE results
   The following characteristics can also be increased/decreased or other influenced/changed based on subjective and/or statistical QoE results: frame rate, refresh interval and behavior, error resiliency, buffer behavior, maximum frame size, peak bit rate, fragmentation, retransmission, and/or other characteristics.
   If the DBA module 106 is turned on:
      QoE can have an impact on rate adaptation (configurable).
      Reporting is controlled by the DBA module 106, in one embodiment.
   If the DBA module 106 is turned off:
      The QoE server module 108 does not have an impact on rate adaptation, in one embodiment, but can have an impact on rate adaptation in another embodiment.
      Reporting is controlled by the QoE server module 108 in one embodiment, and is controlled by other modules or components in another embodiment.
   If both DBA and QoE modules 104 and 108 are turned off, reporting can controlled by the QoS module 112, in an embodiment.
6. The QoE server module 108 can operate in one or both of the following modes:
   Statistics mode
   Subjective mode
   Details: Metrics coming back to the server 100 from the client devices 104 can be used/organized within the QoE server module 108 in many ways. One way is the “Statistics mode.” Here, the QoE server module 108 is organizing the statistics of the metrics in the form of minimum, maximum etc. A second way is the “Subjective mode.” Here, the QoE server module 108 is organizing the metrics it received by mapping them to a Quality of Service class. Therefore, for example, after looking at the metrics, the QoE server module 108 may determine that a particular metric belongs to the MEDIUM quality class. As such, this information could be used for validation purposes. For example, if the client device 104 subscribed to a HIGH quality class but for this particular session based on the metrics the server 100 received, it was determined that this session only belonged to the MEDIUM quality class, then such information is useful for a number of purposes. There could potentially be a number of other analysis of the metrics the QoE server module 108 receives.
7. The QoE Statistics Mode:
   Computed at media or session level
   Measured over a single period or the whole session
   Computes minimum, maximum, average and std deviation of at least:
      Corruption duration
      Rebuffering duration
      Initial buffering duration
      Successive loss
8. The QoE Subjective Mode:
   Computed at media or session level
   Measured over the whole session (no single period reports)
   Provides a mapping to a predefined QoS-class
      Best-effort or Streaming Class,
      Low, Medium, or High QoE Class.
   Provides an isolation of the possible problem location:
   Link layer
   Network protocol stack
   Codec stack problem
   Client application problem
   Clip problem
   Other

Example embodiments of the QoE server module 108 are described in further detail in published PCT Application Serial No. PCT/US2004/027618, entitled “QUALITY OF EXPERIENCE (QoE) METHOD AND APPARATUS FOR WIRELESS COMMUNICATION NETWORKS,” filed Aug. 23, 2004 and also described in further detail in its related priority applications, all of which are assigned to the same assignee as the present application, and incorporated herein by reference in their entireties.

With regards to QoS, the QoS module 112 of one embodiment leverages the negotiated maximum bit rate, guaranteed bit rate, and maximum transfer delay parameters between the client devices 104 and the network. The QoS module 112 also leverages any additional network layer data such as loss, delay, and other metrics associated with high-level device and network metrics. A QoS framework on which one embodiment of the QoS module 112 is based specifies a guaranteed service level using deterministic and objective methods of analyzing and providing consistent and predictable data delivery service, and is typically implemented as network QoS.

With regards to the transcoder and other module(s) 110, an embodiment receives a single input (such as a raw video) from the content provider(s) 102 and transforms the input into a plurality of simultaneous outputs (such as output video streams) having unique characteristics. Thus, a one-to-many technique is provided for transforming input data into output data in a single transcoding session. For example, the outputs may have different bit rates, frame rates, resolution, encoding formats, color schemes, or other characteristics that are tailored based on either or both client device characteristics or bandwidth conditions. The client devices 104 can thus have an optimum output provided to them by the server 100 and can switch to some other output as circumstances dictate, such as circumstances resulting from determinations made by the QoE module server 108, the DBA module 106, and/orthe QoS module 112. Example embodiments of such transcoding techniques are described in further detail in U.S. patent application Ser. No. 09/502,390, entitled “COMPUTER PROGRAM PRODUCT FOR TRANSFORMING STREAMING VIDEO DATA,” filed Feb. 10, 2000, assigned to the same assignee as the present application, and incorporated herein by reference in its entirety.

All of these modules cooperatively ensure that the user experience in a multicasting and/or broadcasting environment is as expected and is monitored throughout the streaming session even over severely variable network conditions. For example, if the DBA module 106 determines that a particular client device 104 needs to change to a lower bit rate signal, then the server 100 can instruct or otherwise cause that client device 104 to switch over to a lower bit rate signal generated by the transcoder 110. Similar switching to other signals and/or adaptation of signals can be performed based on determinations made by the QoE server module 108 and the QoS module 112.

While the QoE server module 108 and other modules of FIG. 1 are shown as residing in the server 100, it is appreciated that the QoE server module 108 (or any of the other modules) can be suitably located elsewhere in a wireless or hardwired network. For example, the QoE server module 108 can be located at a proxy device, router, switch, or other network component, including at client device(s) 104 in some embodiments.

Continuing on with the description of FIG. 1, the server 100 and the client devices 104 can communicate with one another using one or more protocol communications 114. The Multimedia Broadcast/Multicast Service (MBMS) configuration and its associated protocols can be used in one embodiment to allow communication between the server 100 and the client devices 104. MBMS further leverages other communication protocols and services, such as Packet Switched Streaming (PSS), Real Time Transport Protocol (RTP), Session Description Protocol (SDP), User Datagram Protocol (UDP), Hypertext Transfer Protocol (HTTP), Internet Protocol (IP), Real Time Transport Control Protocol (RTCP), File Delivery Over Unidirectional Transport (FLUTE), and others. These and/or other protocols and services and methods can be used in other embodiments that do not involve MBMS.

In one embodiment, the protocol communications can be performed in a multicast and/or broadcast manner over a wireless and/or wired network 118. Examples of wireless networks include cellular or other RF, satellite, and optical networks. Examples of wired networks include a Public Switched Telephone Network (PSTN), a coaxial cable network, and other types of networks. In one embodiment, a combination of wired and wireless networks can be implemented in the network 118. In yet another embodiment, the network 118 can include or be coupled to the Internet.

In one embodiment, one or more back channels or other channel(s) 116 can be provided for additional communication between the server 100 and each of the client devices 104. The channel 116 can also comprise the same channel itself used for delivering the content (such as multicast/broadcast streaming content) from the server 100 to each client device 104. One purpose of the channel 116 is to communicate QoE, DBA, and/or QoS metric data from the client devices 104 to the respective modules of the server 100. For example, RTCP receiver report (RR) packets that convey streaming statistics can be communicated by the client devices 104 to the server 100.

Another purpose of the channel 116 can be to communicate control signals from the server 100 to any one of the client devices 104. For instance, the channel 116 can be used to convey instructions from the server 100 to a particular client device 104 to switch to a different stream in the same multicast group or to a different stream in some other multicast group.

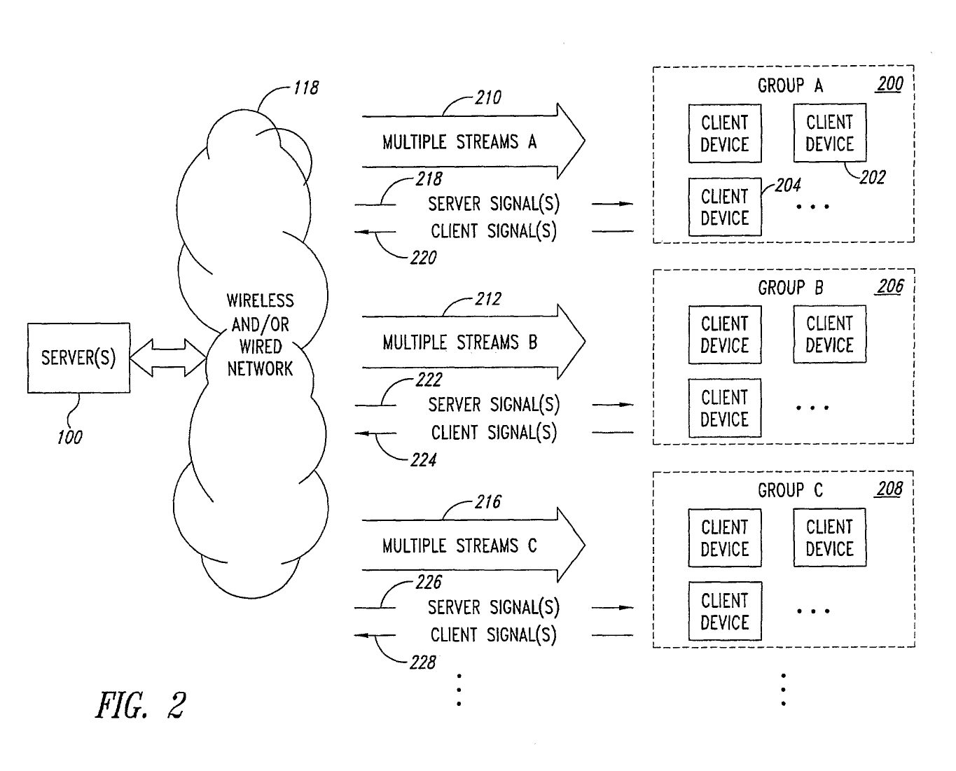

FIG. 2 illustrates delivery of content to client devices according to one embodiment, for example streaming in a multicast environment. Client devices are subscribed to or otherwise join or are subscribed to multicast groups A, B, C, etc. (labeled 200, 206, and 208, respectively). For instance, client devices 202, 204, etc. are subscribers to Multicast Group A (200). Each of the groups 200, 206, and 208 can include at least one to any suitable number of client devices.

Different criteria can be used to define a “group.” For example, groups can be defined according to some signal characteristic (e.g., group 200 is associated with signals having bit rates W bps to X bps, group 200 is associated with signals having bit rates Y bps to Z bps, group 200 is associated with signals having W bps and Z bps but not X bps, and so forth). Other types of signal characteristic(s) that can be used to define groups include resolution, encoding format, frame rate, color scheme, and others. In some instances, similar signal characteristics can be present between groups while other signal characteristics are different.

Other criteria or combinations thereof, alternatively or additionally to signal characteristics, can be used to define the groups 200, 206, and 208. Groups may be defined, for example, based on geographic locations and/or IP addresses of client devices and/or server(s) 100. Groups may also be defined based on content type, such as streaming video versus streaming audio versus graphical messaging, etc.

Still other possibilities include business rules, such as defining groups based on user costs for subscription (e.g., “basic,” “intermediate,” or “premium” subscription packages, wherein more or better services and products can be made available to a customer depending on the subscription package chosen by the customer). A subscription package can be associated with a particular stream. In these or other types of grouping definitions, supplemental content can be added to the same basic content provided by the streams. For instance, all streams may provide the same video program, yet some streams may not include commercials or advertisements if the user has chosen a “premium” subscription package that excludes advertisements and commercials. Thus, the user can join a “premium” multicast group that streams an uninterrupted signal that does not have advertisements and commercials. In still other embodiments, the type of supplemental content provided along with the basic content can be customized for a single one or a plurality of users based at least in part on user profile data that specifies the subscription level of the user, as well as other possible data about the user, such as interests, demographics, favorites, etc.

In an embodiment, the other module 110 can perform evaluation and enforcement associated with business rules. For example, the other module 100 can evaluate user profile data and their subscription levels to determine which stream should be delivered to a particular group or user. Such evaluation can include determining whether a different stream should be delivered to a user or group, such as if a user changes subscription packages to a higher or lower level, and can further perform other operations associated with enforcing business rules. In an embodiment, the transcoder of the module 110 can also perform transcoding that is based at least in part on business rules. For instance, if a user is currently subscribed to receive a low resolution stream and then subscribes to receive a higher resolution stream, the transcoder can transform the stream being provided to that user's group such that the user is receiving a higher resolution stream.

Still yet other possibilities include defining groups based on subject matter of their content, such as genre (drama, comedy, musical, etc.) of the content they provide an/or based on time of transmission. In short, embodiments can use any one or more of possible criteria to define a multicasting group.

In an embodiment, the groups 200, 206, and 208 each respectively receive multiple streams 210, 212, and 216 that their subscribing client devices can tune to receive the content carried by the streams. For instance, the group 200 can receive the multiple streams 200 from the server 100 via the network 118, with each stream having one or more of a different bit rate, resolution, frame rate, or other signal characteristic. Consequently, the subscribing client devices in group 200 can each tune to one particular stream from the multiple streams 200 that is most optimum, such as a stream that has a bit rate compatible with the capabilities of the respective subscribing client device.

In another embodiment, multiple streams 210, 212, and 216 are available, but only a single stream at a time is active per group. Thus, all client devices in the group receive the same stream, which can be updated based on DBA, QoE, etc. metric data. In such an embodiment, all client devices seamlessly receive an updated/different stream available in the same group, if conditions dictate. If there are certain client devices in the same group wherein the updated stream is not optimum, then such client device(s) can remain in the same group and receive that updated stream, or switch to some other group to receive a more optimum stream.

In an embodiment, the server 100 has the capability to provide server signals 218, 222, and 226 (or other data or control commands) to any client device in any of the groups 200, 206, and 208, respectively. For example, such server signals 218, 222, and 226 can be communicated via the channel 116 (shown in FIG. 1), and can include instructions for one or more client devices to tune to a particular signal available for their multicast group, instructions for one or more client devices to tune to a particular signal available in another multicast group, requests for QoE/DBA/QoS metric data (including streaming statistics and QoE reports, which can be sent by client devices before, during, and/or after streaming sessions), instructions for one or more client devices to connect or disconnect from the group (or acknowledgement of a client device's request to connect or disconnect), QoE negotiation data, or other information or commands that may be associated with the streaming session.

Return data and/or requests provided by the client devices in the groups 200, 206, and 208 can be provided back to the server 100 as client signals 220, 224, and 228, respectively, via the channel 116. Examples of such return data and/or requests, include but are not limited to, QoE/DBA/QoS metric data (including the QoE reports mentioned above, requests to connect to or disconnect from a multicast group, request to the server to identify a stream and/or group that is optimum for the particular client device, QoE negotiation data, or other commands and data.

As described above, an embodiment allows at least one client device to switch to a different stream if, for example, the server 100 determines that QoE or DBA results indicate that a different stream may provide more optimum service. According to one embodiment, the server 100 may signal a single client device (such as the client device 202 in the group 200) to make the switch and/or may signal multiple client devices in the same group (such as the client devices 202 and 204 in the group 200) to make the switch.

In yet another embodiment described above, client devices in one group all receive the same stream (e.g., same bitrate), rather than individually tailored streams-even though such client devices might be identified with different needs. Therefore in such an embodiment, the client devices may be provided with an updated stream in unison, and/or client devices for which the updated stream is not optimum can have the option of being switched to another group.

Server signal(s) to switch to a different stream (such as a stream with a different bit rate) can include signals to switch to a different stream in the same group. That is, since the server 100 provides multiple different streams to each group 200, 206, and 208, the client devices therein have more flexibility to choose a different stream available in the same group instead of having to switch to another group. Preserving the group “membership” of client devices (i.e., keeping client devices in the same groups) minimizes the potentially adverse affects of “group switching” discussed previously.

In an embodiment, switching between groups is made possible, for example if there is not a suitable stream available in the existing group for client devices that need to change streams. In such a scenario, the server 100 can signal such client devices to change to the new group and/or the server 100 can provide information to such client devices to enable them to decide when and which group to switch to. Again, QoE metric data, DBA metric data, or other data indicative of client device characteristics and/or bandwidth conditions (which may all change dynamically) can be used to determined whether, when, and where client devices should switch.

In one embodiment, layer techniques can be used to provide the multiple streams 210, 212, 216, etc. For example, a single base layer can be provided to each group 200, 206, and 208, or multiple base layers can be provided to each group 200, 206, and 208 by way of separate multiple streams. The base layers can be completely different between the groups, or some of the base layers may be the same.

In addition to the base layer(s), multiple streams to each group 200, 206, and 208 can provide the various enhancement layers. The various enhancement layers can have different bit rates, for example, and then the client devices and/or the server 100 can select the specific enhancement layers to be used by each client device. In yet other levels of granularity, each enhancement layer itself can be assigned a plurality of different bit rates.

Layering may also be alternatively or additionally performed based on other characteristics, such as client device characteristics, codec types, frame rate, resolution, color scheme, and other criteria. As before, the client devices can switch, if needed, to different layers available in the same group, or switch to different layers available in other groups.

In a broadcast environment, similar signals can be provided as those illustrated in FIG. 2. That is, multiple streams having different characteristics can be made available to the client devices. Initially, the server 100 will transmit (or the client devices will tune to) a particular one of the streams that would result in the most optimum result, such as a stream that has the optimum bit rate. QoE, DBA, QoS, and/or other metric data may be gathered before, during, or after the streaming session to evaluate whether a switch to a different stream should be performed. If the evaluation of the metric data suggests that a change may be needed, then the client device can be switched to a more optimum stream.

Since a broadcast involves sending a same (or similar) content to all client devices, groups need not necessarily be defined in an embodiment (i.e., there is only “one” broadcast group). However, it is appreciated that multiple broadcast groups can indeed be defined, using the similar criteria described above for defining multicast groups.

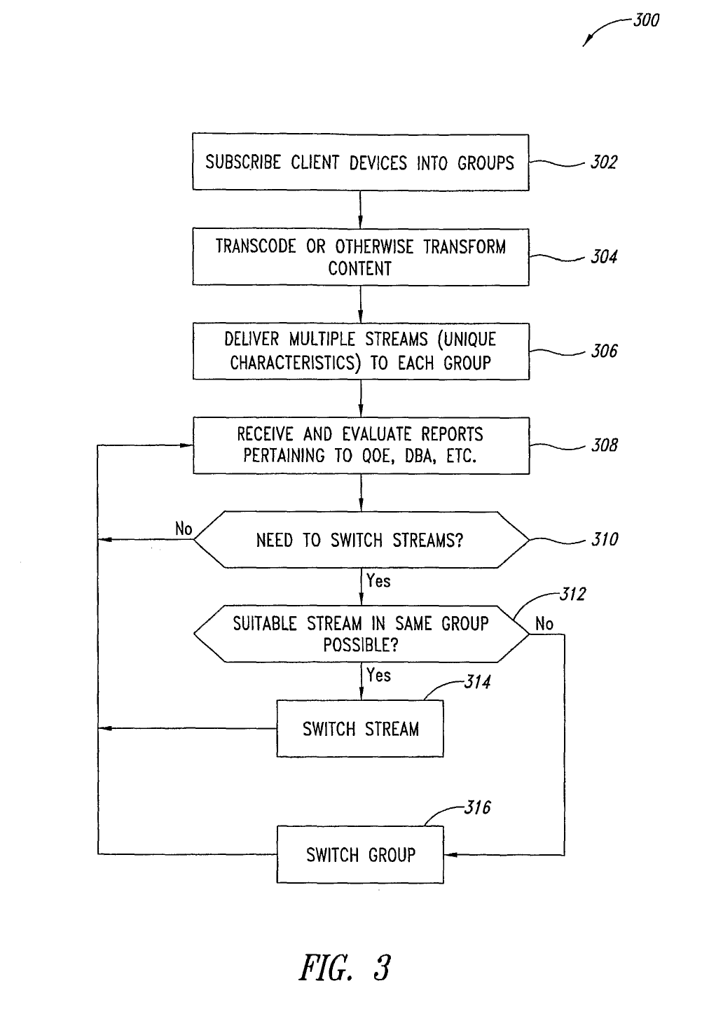

FIG. 3 is a flowchart of an embodiment of a technique 300 to deliver content to client devices, such as via streaming in a multicast or broadcast environment. In an embodiment, at least some of the elements in the technique 300 can be implemented in software or other machine-readable instruction stored on a machine-readable medium, such as memory in the server 100 that has code stored thereon executable by one or more processors. It is appreciated that the various operations shown in the technique 300 need not necessarily occur in the exact order shown, and that various operations can be suitably added, removed, modified, combined, or any combination thereof.

At a block 302 groups (such as multicast groups) are configured and client devices are subscribed into the groups. For example, client devices may join a group to receive a broadcast of some particular streaming video program. At a block 304, content is received from the content provider(s) 102 and transcoded or otherwise transformed by the transcoder 110 of the server 110 into a plurality of unique simultaneous output streams, such as simultaneous video streams having different bit rates.

At a block 306, the plurality of output streams are delivered via the groups to the client devices, in such a manner that multiple different output streams are made available for each group. The client devices in each group can then tune in to receive the stream that is most optimum in one embodiment. In another embodiment as described above, client devices in a same group receive the same stream. In one embodiment, the server 100 dictates to the client devices as to which stream to tune—in another embodiment, the client devices determine which stream they wish to receive.

At a block 308, metric data is communicated from the client devices to the server 100. This metric data can include the QoE metric data, DBA metric data, and/or QoS metric data described above or other pertinent metric data that provides an indication of the quality of the experience/service. The metric data can be gathered and communicated before, during, or after streaming sessions. The various modules of the server 100 shown in FIG. 1 evaluate the metric data.

At a block 310, the server 100 determines whether one or more of the client devices need to switch streams. If there is no need to switch streams, then the server 100 continues to receive and evaluate metric data at a block 308. If the evaluation of the metric data recommends a change, then the server 100 determines at a block 312 whether a suitable stream is available in the same multicast group or otherwise determines whether switching within the group is possible.

If switching within the group is possible, then the client device(s) are switched to the new stream at a block 314. Else, the server 100 looks for a suitable stream in another group. If the server 100 locates such a stream, then the client device(s) are switched to that stream (in a different group) at a block 316. The process repeats to continually monitor the metric data to determine whether stream switching needs to be subsequently performed.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments, including what is described in the Abstract, is not intended to be exhaustive or to limit the invention to the precise forms disclosed. While specific embodiments and examples are described herein for illustrative purposes, various equivalent modifications are possible within the scope of the invention and can be made without deviating from the spirit and scope of the invention.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method to deliver streaming content to a plurality of client devices, the method comprising:
associating client devices with groups;
delivering multiple simultaneous unique streams to each group to allow client devices in each group to respectively receive one of the unique streams;
receiving and evaluating metric data pertaining to the delivery of the streams to the client devices;
based at least in part on the evaluated metric data, causing at least one of the client devices to switch to a different stream in a same group that is more optimum than a current stream in the same group; and
based at least in part on the evaluated metric data, causing the at least one of the client devices to switch to a different stream in a different group that is more optimum than a current stream in a current group, if the optimum stream is unavailable in the current group.

2. The method of claim 1 wherein associating the client devices with groups includes associating different client devices with respective different multicast groups.

3. The method of claim 1 wherein associating the client devices with groups includes associating the client devices with at least one broadcast group.

4. The method of claim 1 wherein causing the at least one client device to switch to a different stream includes causing that client device to switch to a stream that has a different characteristic that is based on client device capabilities and channel conditions, wherein such characteristic can including bit rate, frame rate, resolution, encoding format, color scheme, and user profile information wherein at least one of these characteristics can be the same for the unique streams while some other characteristic is different among the streams.

5. The method of claim 1 wherein receiving and evaluation metric data includes receiving and evaluating either or both:
quality of experience (QoE) metric data; and
dynamic bandwidth adaptation (DBA) metric data pertaining to client device characteristics and channel conditions.

6. The method of claim 1 wherein causing the at least one of the client devices to switch to a different stream includes sending server-generated instructions to a plurality of client devices.

7. An article of manufacture, comprising:
a machine-readable medium having instructions stored thereon that are executable by a processor to deliver streaming content to a plurality of client devices associated with multicast groups, by:
making available multiple unique streams to each group to allow most client devices in each multicast group to receive one of the unique streams that is optimum for the group as a whole;
receiving and evaluating metric data pertaining to the delivery of the streams to the client devices;
based at least in part on the evaluated metric data, causing most of the client devices to switch to a different stream in a same multicast group that is more optimum than a current stream in the same multicast group; and
based at least in part on the evaluated metric data, causing at least other ones of the client devices to switch to a different stream in a different multicast group that is more optimum than a current stream in a current multicast group, if the optimum stream is unavailable in the current multicast group, and otherwise causing such client devices to remain in the current multicast group.

8. The article of manufacture of claim 7 wherein the instructions to cause the at least one client device to switch to a different stream includes instructions to cause that client device to switch to a stream that has a different bit rate.

9. The article of manufacture of claim 7 wherein the machine-readable medium further includes instructions stored thereon to transform, including transcode, a single input having content into the plurality of simultaneous unique streams having the content.

10. The article of manufacture of claim 7 wherein the instructions to receive and evaluate metric data includes instructions to receive and evaluate either or both:
quality of experience (QoE) metric data; and
dynamic bandwidth adaptation (DBA) metric data pertaining to client device characteristics and channel conditions, wherein the QoE and the DBA metric data can pertain to some of the client devices in a group and be used to determine a different stream to provide to all client devices in a group.

11. The article of manufacture of claim 7 wherein the instructions to deliver multiple simultaneous unique streams include instructions to deliver base layers and enhancement layers as multiple unique streams.

12. A system for delivering streaming content to a plurality of client devices, the system comprising:
means for associating client devices with groups;
means for delivering multiple simultaneous unique streams to each group to allow client devices in each group to respectively receive one of the unique streams;
means for receiving and for evaluating metric data pertaining to the delivery of the streams to the client devices;
means for causing at least one of the client devices to switch to a different stream in a same group that is more optimum than a current stream in the same group, based at least in part on the evaluated metric data; and
means for causing the at least one of the client devices to switch to a different stream in a different group that is more optimum than a current stream in a current group, if the optimum stream is unavailable in the current group, based at least in part on the evaluated metric data.

13. The system of claim 12 wherein the means for receiving and for evaluating the metric data includes means for receiving and for evaluating quality of experience (QoE) metric data, the system further comprising:
means for negotiating QoE metric data between a server and a client device; and
means for evaluating the QoE metric data in conjunction with rate adaptation data to determine whether to switch to a different stream.

14. The system of claim 12, further comprising means for instructing either or both single client devices and groups of client devices to switch to a different stream.

15. An apparatus to deliver streaming content to a plurality of client devices associated with multicast groups, the apparatus comprising:
a server to deliver multiple unique streams to each group to allow client devices in each multicast group to receive one of the unique streams; and
at least one module in communication with the server to receive and evaluate metric data pertaining to the delivery of the streams to the client devices;
wherein based at least in part on the evaluated metric data, the server can cause at least one of the client devices to switch to a different stream in a same multicast group that is more optimum than a current stream in the same multicast group; and
wherein based at least in part on the evaluated metric data, the server can cause the at least one of the client devices to switch to a different stream in a different multicast group that is more optimum than a current stream in a current multicast group, if the optimum stream is unavailable in the current multicast group.

16. The apparatus of claim 15 wherein the at least one module includes:
a first module to receive and evaluate quality of experience (QoE) metric data; and
a second module to receive and evaluate dynamic bandwidth adaptation (DBA) metric data pertaining to client device characteristics and channel conditions, at least some of either or both the QoE metric data and DBA metric data being usable to determine whether to switch to a different stream.

17. The apparatus of claim 15, further comprising:
a third module to receive and evaluate metric data in addition to the QoE and DBA metric data; and
at least an additional module, including a fourth module to transcode a single input into the plurality of simultaneous unique streams.

18. The apparatus of claim 15, further comprising:
means for delivering multiple unique streams to client devices in a broadcast environment; and
means for switching at least some of the client devices in the broadcast environment from one stream to another stream, based at least in part on metric data.

19. The apparatus of claim 15 wherein the streams are unique in that they include at least one characteristic that is based on client device capabilities and channel conditions, wherein such characteristic can including bit rate, frame rate, resolution, encoding format, and color scheme, wherein at least one of these characteristics can be the same for the unique streams while some other characteristic is different.

20. An apparatus to deliver streaming content to a plurality of client devices associated with multicast groups, the apparatus comprising:
a server to deliver multiple unique streams to each group to allow client devices in each multicast group to receive one of the unique streams, wherein at least some of the groups can be defined based on business rules that can include subscription packages; and
at least one module in communication with the server to evaluate and enforce the business rules to determine the subscription packages and associated streams to deliver to the client devices, and
wherein based at least in part on the evaluated business rules, the server can cause at least one of the client devices to switch to a different stream in a same multicast group or different multicast group if the subscription package of such client devices changes.

21. The apparatus of claim 20 wherein the subscription packages can be associated with streams having supplemental content that is tailored to at least some users of the client devices based at least in part on profile data.

22. The apparatus of claim 20, further comprising a transcoder to transform an input stream into the server into a plurality of different output streams that have been tailored to the groups based at least in part on the business rules.
